(19) United States
(12) Patent Application Publication
(10) Pub. No.: US 2008/0002772 A1
(43) Pub. Date: Jan. 3, 2008

(54) Motion vector estimation method

(75) Inventors: Jiqiang Song, Guang Dong (CN); Siu Hei Titan Yim, Kowloon (HK)

Correspondence Address: OSTROLENK FABER GERB & SOFFEN, 1180 AVENUE OF THE AMERICAS, NEW YORK, NY, 100368403, US

(73) Assignee: Hong Kong Applied Science and Technology Research Institute Company Limited

(21) Appl. No.: 11/477,184

(22) Filed: Jun. 28, 2006

(51) Int. Cl. H04N 11/02; H04N 11/04

(52) U.S. Cl. 375/240.16; 375/240.24

(57) ABSTRACT

A method (100) is disclosed of estimating a motion vector between a first pixel block in a current frame and a second pixel block in a reference frame. The method starts by predicting (110) a first motion vector based upon at least the motion vector of a third pixel block. The best motion vector is then selected (150) from a group of motion vectors in a first pattern (140) around the first motion vector. The first pattern is based upon the direction of the first motion vector and distortion resulting from applying the first motion vector. A second pattern (170) is then scaled based upon a distortion level resulting from applying the best motion vector, and a replacement best motion vector is selected (180) from a group of motion vectors in the second pattern around the best motion vector. Finally, the best motion vector is refined to sub-pixel resolution by selecting (640, 665) a replacement best motion vector from a group of motion vectors in a third pattern in the inter-pixel neighbourhood of the best motion vector.

### FIELD OF THE INVENTION

The present invention relates generally to video compression and, in particular, to a motion vector estimation method for estimating a motion vector between a pixel block in a current frame and a pixel block in a reference frame.

### BACKGROUND

Vast amounts of digital data are created constantly. Data compression enables such digital data to be transmitted or stored using fewer bits.

Video data contains large amounts of spatial and temporal redundancy. The spatial and temporal redundancy may be exploited to more effectively compress the video data. Image compression techniques are typically used to encode individual frames, thereby exploiting the spatial redundancy. In order to exploit the temporal redundancy, predictive coding is used where a current frame is predicted based on previous coded frames.

The Moving Picture Experts Group (MPEG) standard for video compression defines three types of coded frames, namely:

I-frame: Intra-coded frame which is coded independently of all other frames;

P-frame: Predictively coded frame which is coded based on a previous coded frame; and

B-frame: Bi-directional predicted frame which is coded based on previous and future coded frames.

When the video includes motion, the simple solution of differencing frames fails to provide efficient compression. In order to compensate for motion, motion compensated prediction is used. The first step in motion compensated prediction involves motion estimation.

For “real-world” video compression, block-matching motion estimation is often used where each frame is partitioned into blocks, and the motion of each block is estimated. Block-matching motion estimation avoids the need to identify objects in each frame of the video. For each block in the current frame a best matching block in a previous and/or future frame (referred to as the reference frame) is sought, and the displacement between the best matching pair of blocks is called a motion vector.

The search for a best matching block in the reference frame may be performed by sequentially searching a window in the reference frame, with the window being centered at the position of the block under consideration in the current frame. However, such a “full search” or “sequential search” strategy is very costly. Other search strategies exist, including the “2D Logarithmic search” and the search according to the H.261 standard.

Even tough search strategies exist that are less costly than the full search strategy, there is still a need for a search strategies with improved search patterns.

### SUMMARY

It is an object of the present invention to provide an improved motion vector estimation for use in video compression.

According to a first aspect of the present disclosure invention, there is provided a method of estimating a motion vector between a first pixel block in a current frame and a second pixel block in a reference frame. The method comprising the steps of:

predicting a first motion vector based upon at least the motion vector of a third pixel block; and

selecting the best motion vector from a group of motion vectors in a first pattern around said first motion vector, said first pattern being based upon the direction of said first motion vector and distortion resulting from applying said first motion vector.

According to another aspect of the present invention, there is provided an apparatus for implementing the aforementioned method.

According to another aspect of the present invention there is provided a computer program product including a computer readable medium having recorded thereon a computer program for implementing the method described above.

Other aspects of the invention are also disclosed.

### BRIEF DESCRIPTION OF THE DRAWINGS

One or more embodiments of the present invention will now be described with reference to the drawings, in which:

FIG. 1 shows a schematic flow diagram of a method of estimating a motion vector between a pixel block in the current frame and a pixel block in the reference frame;

FIG. 2 is a schematic flow diagram of estimating an integer motion vector;

FIG. 3 is a schematic flow diagram of generating a set of motion vector predictions;

FIG. 4 is a schematic flow diagram of generating a non-iterative search pattern;

FIG. 5A illustrates an isotropic search pattern;

FIG. 5B illustrates a directional search pattern;

FIG. 6 is a schematic flow diagram of generating an iterative search pattern;

FIG. 7 illustrates the isotropic search pattern used when generating the iterative search pattern;

FIG. 8 is a schematic flow diagram of refining an integer level motion vector by estimating an inter-pixel level motion vector;

FIG. 9 shows inter-pixel grid positions;

FIG. 10 is a schematic block diagram of a computing device upon which arrangements described can be practiced; and

FIGS. 11A to 11C and 12A to 12C illustrate the manner in which a selection of quarter half positions is made.

### DETAILED DESCRIPTION

Where reference is made in drawings to steps which have the same reference numerals those steps have for the purposes of this description the same function(s) or operation(s), unless the contrary intention appears.

The present invention relates to block-matching motion estimation. Accordingly, prior to motion vector estimation, a current frame in the video sequence is partitioned into non-overlapping blocks. A motion vector is estimated for each block in the current frame, with each motion vector describing the spatial displacement between the associated block in the current frame and a best matching block in the reference frame.

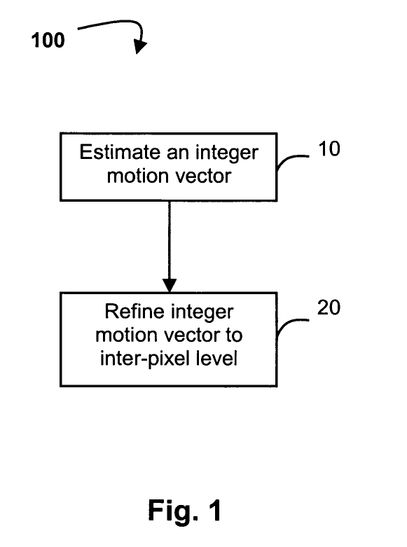

FIG. 1 shows a schematic flow diagram of a method 100 of estimating a motion vector between a pixel block in the current frame and a pixel block in the reference frame. The method 100 comprises two main steps. The first step 10 estimates an integer motion vector, in other words to pixel grid resolution, whereas step 20 refines the integer motion vector estimated in step 10 in order to estimate a motion vector to inter-pixel resolution. Steps 10 and 20 are described in more detail below.

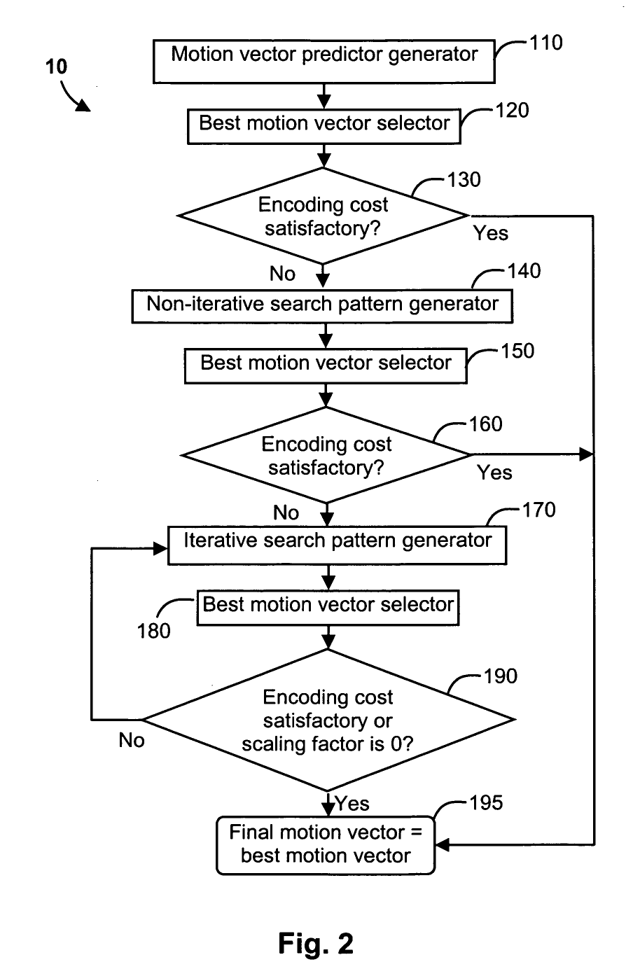

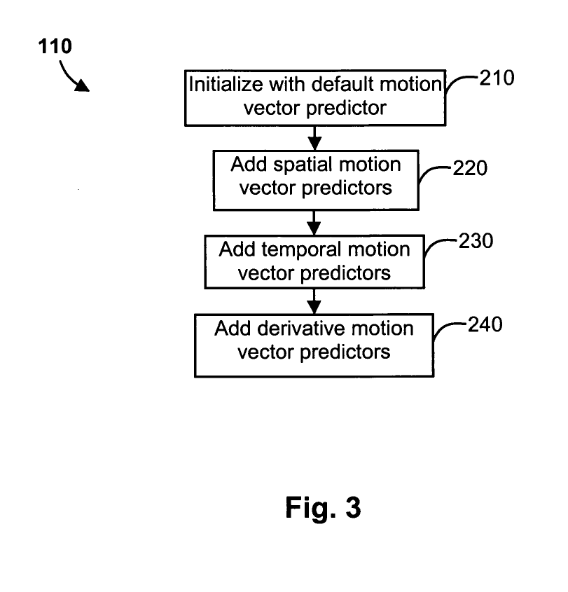

FIG. 2 is a schematic flow diagram of step 10 (FIG. 1) showing the sub-steps of step 10 where the integer motion vector is estimated. Step 10 starts in sub-step 110 where a set of motion vector predictions are generated as motion vector candidates based on preset heuristics. FIG. 3 is a schematic flow diagram of step 110 of generating the set of motion vector predictions in more detail. Step 110 starts in sub-step 210 where the set of motion vector predictions is initialised with a default predictor, namely (0, 0). In sub-step 220 spatial motion vector predictions are added to the set of motion vector predictions if the pixel block under consideration is not the very first pixel block of the current frame being encoded. For example, the motion vectors of previously encoded pixel blocks may be used as the spatial motion vector predictions. In particular, the motion vectors of neighbouring blocks located immediate left, above, above-left and above-right of the block under consideration may be added to the set of motion vector predictions.

Next, in sub-step 230 temporal motion vector predictions are added to the set of motion vector predictions when the frame of pixel block under consideration is not the very first predictively coded frame (P-frame) after an intra-coded frame (I-frame). In that case the motion vectors of the neighbours of the collocated pixel block on the previous P-frame are added to the set of motion vector predictions.

Derivative motion vector predictions are added to the set of motion vector predictions in sub-step 240. The derivative motion vectors are derived from the spatial motion vector predictions (from sub-step 220) and the temporal motion vector predictions (from sub-step 230) by combination or computation. For example, if there are two motion vector predictions A=(x_{A}, y_{A}) and B=(x_{B}, y_{B}), a derivative motion vector prediction C=(x_{C}, y_{C}) may be defined by setting x_{C}=x_{A} and y_{C}=y_{B}, or by setting x_{C}=┌(x_{A}+x_{B})/2┐ and y_{C}=┌(y_{A}+y_{B})/2┐, wherein ┌ ┐ represents the ceiling function.

Referring again to FIG. 2, following sub-step 110 and in sub-step 120, the best motion vector from all the available motion vector candidates in the set of motion vector predictions is selected using predetermined motion vector evaluation criteria. Such motion vector evaluation criteria may include for example using a minimal encoding cost criteria: (distortion+λ*MV_cost), wherein the variable distortion represents the difference between the pixel block under consideration and the pixel block on the reference frame, the variable MV_cost represents the cost of encoding the motion vector, and the parameter λ is the Lagrangian multiplier which is used to adjust the relative weights of the variables distortion and MV_cost.

Step 10 then determines in sub-step 130 whether the encoding cost of the current best motion vector is already satisfactory by determining whether the encoding cost is lower than a predefined threshold. The encoding cost may be calculated as a weighted sum of distortion (using the known Sum of Absolute pixel Difference (SAD) or Sum of Absolute pixel Transformed Difference (SATD) calculations, or a combination of the SAD and SATD calculations) and motion vector cost.

If it is determined in sub-step 130 that the encoding cost is lower than the predefined threshold then processing proceeds to sub-step 195 where the final motion vector is set to be the best motion vector before step 10 ends.

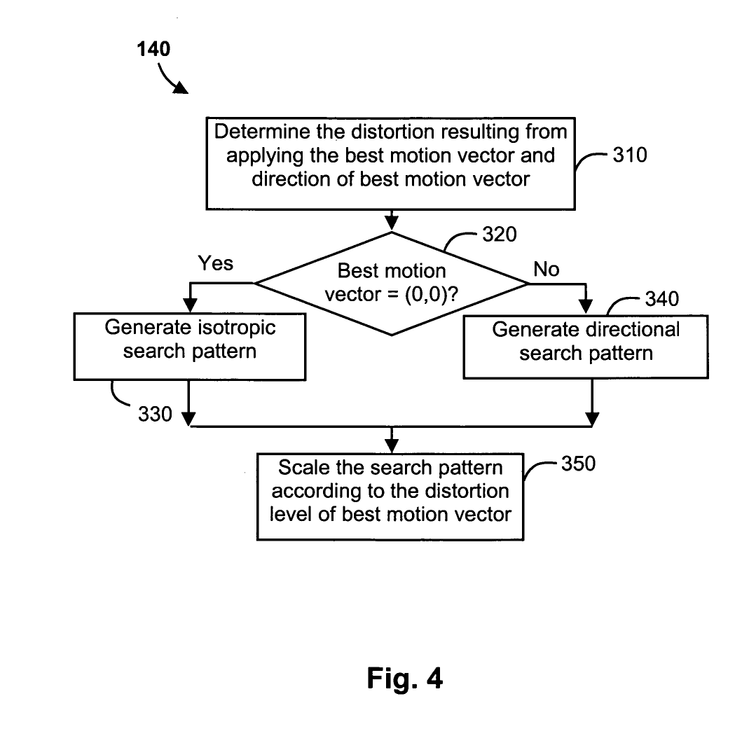

Alternatively, if it is determined in sub-step 130 that the encoding cost is not lower than the predefined threshold then processing proceeds to sub-step 140 where a non-iterative search pattern is generated. FIG. 4 is a schematic flow diagram showing the sub-steps of step 140 of generating a non-iterative search pattern. Step 140 starts in sub-step 310 where the distortion resulting from applying the best motion vector and direction of the best motion vector are calculated. Next, in sub-step 320 it is determined whether the best motion vector is the vector (0,0).

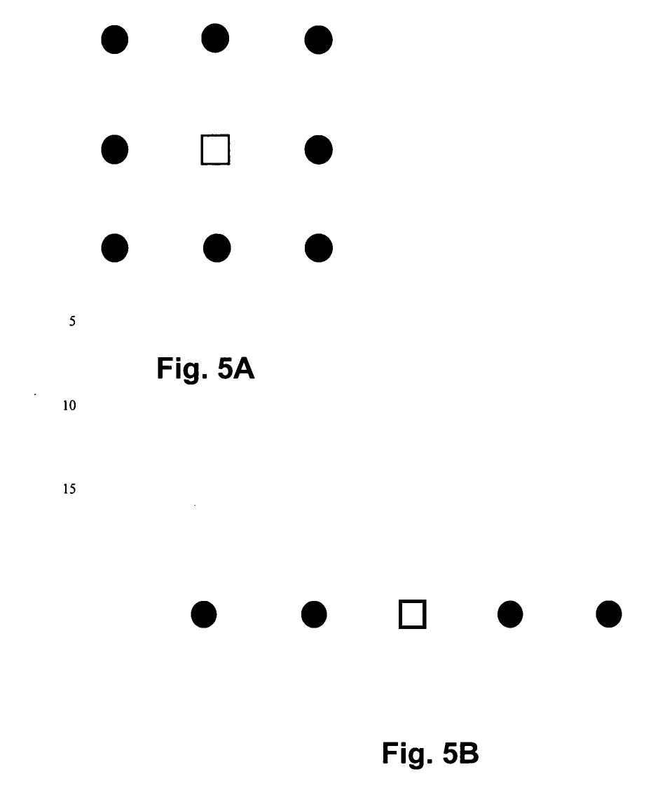

If it is determined in sub-step 320 that the best motion vector is the vector (0,0), then step 140 proceeds to sub-step 330 where an isotropic search pattern is generated. Since the motion vector has no directional information, the search pattern has to cover positions in all directions. An example of an isotropic search pattern is illustrated in FIG. 5A where the centre position illustrates the zero displacement best motion vector, and the search pattern consists of 8 positions in horizontal, vertical and diagonal directions around the centre position, with each of the 8 positions being positioned on pixel grid positions adjacent the zero displacement best motion vector.

If it is determined in sub-step 320 that the best motion vector is not the vector (0,0), then step 140 proceeds to sub-step 340 where a directional search pattern is generated. Firstly, the direction calculated in sub-step 310 is classified as either horizontal, vertical or diagonal. The directional search pattern then consists of positions only in that direction. For example, the search pattern in illustrated in FIG. 5B only consists of 4 positions in the horizontal direction, with 2 positions positioned at pixel grid positions on either side of the centre position, which is the displacement of the best motion vector.

However, the search pattern generated in either sub-step 330 or 340 has a predefined size. Following either sub-step 330 or 340 processing proceeds to sub-step 350 where the search pattern is scaled according to the distortion level that exists when the best motion vector is applied. Usually, a high distortion level means the motion vector is still far from optimal. Therefore, when the distortion level resulting from the best motion vector is high, the search pattern is scaled up from its initial value of 1 in sub-step 350 in order to cover a wider range. Hence, the scaling factor applied to the search pattern is a function of the distortion level.

Referring again to FIG. 2, sub-step 140 of step 10 is followed by sub-step 150 where the best motion vector from the motion vectors according to the non-iterative search pattern is selected using the predetermined motion vector evaluation criteria.

Next, step 10 determines in sub-step 160 whether the encoding cost of the current best motion vector is already satisfactory in a manner similar to that of sub-step 130. If it is determined that the encoding cost is satisfactory then processing proceeds to sub-step 195 where the final motion vector is set to be the best motion vector before step 10 ends.

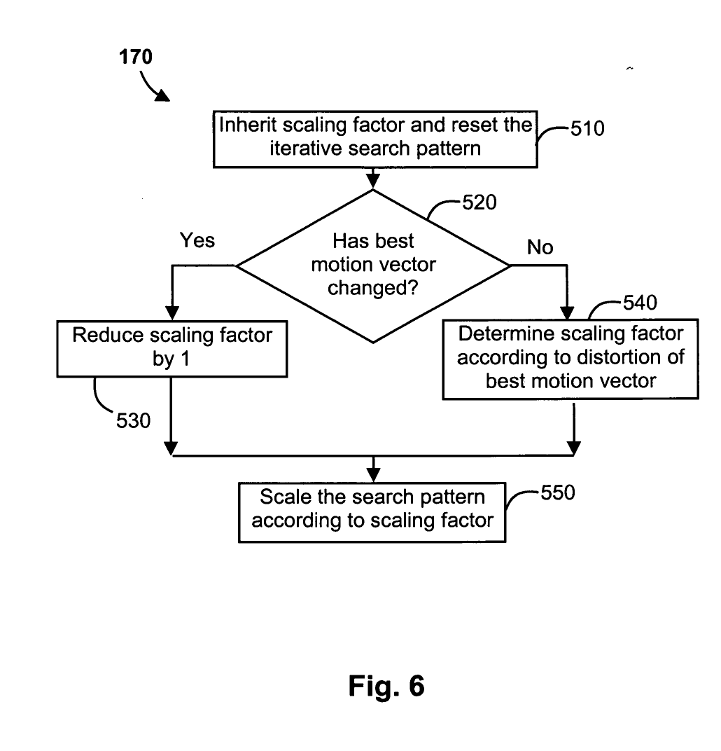

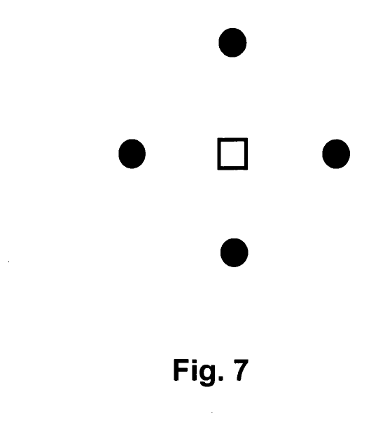

Alternatively, if it is determined in sub-step 160 that the encoding cost is not yet satisfactory, then processing continues to sub-step 170 where an iterative search pattern is generated. FIG. 6 is a schematic flow diagram showing the sub-steps of step 170 of generating an iterative search pattern. Step 170 starts in sub-step 510 where the scaling factor applied in the iterative search is inherited from the last search pattern generator, which is either the scaling factor applied in sub-step 350 (FIG. 4) in the non-iterative search pattern generator, or a previous iteration of the iterative search pattern generator. The iterative search pattern generated by step 170 is always the same, and is usually a simple isotropic pattern like that illustrated in FIG. 7.

In sub-step 520 it is next determined whether the best motion vector has changed during the last search. In the case where the best motion vector has not changed during the last search, step 170 continues to sub-step 530 where the inherited scaling factor is reduced by 1, thus scaling down the search pattern to perform a finer search.

If it is determined in sub-step 520 that the best motion vector has changed during the last search, then processing continues to sub-step 540 where the scaling factor is determined according to the distortion level introduced when the best motion vector is applied.

Step 170 ends in sub-step 550 where the search pattern is scaled according to the scaling factor determined in either sub-step 530 or 540.

Referring again to FIG. 2, following the generation of the iterative search pattern in sub-step 170, the method 100 selects in sub-step 180 the best motion vector from the motion vector according to the iterative search pattern. Sub-step 180 is followed by sub-step 190 where it is determined whether the encoding cost of the current best motion vector is satisfactory by determining whether the encoding cost is lower than the predefined threshold. If the encoding cost of the current best motion vector is satisfactory then processing continues to sub-step 195. If it is determined in sub-step 190 that the encoding cost of the current best motion vector is not yet satisfactory then processing returns to sub-step 170 where the iterative search pattern is adjusted by determining a new scaling factor.

Sub-steps 170 to 190 are repeated until it is determined in sub-step 190 that the encoding cost of the current best motion vector is satisfactory or that the scaling factor applied in sub-step 170 has already been reduced to 0. When the scaling factor has already been reduced to 0 it means that the best motion vector has not changed during the last iteration of steps 170 to 190 because the search pattern was already reached the minimum size. That best motion vector is then designated as the final motion vector in sub-step 195.

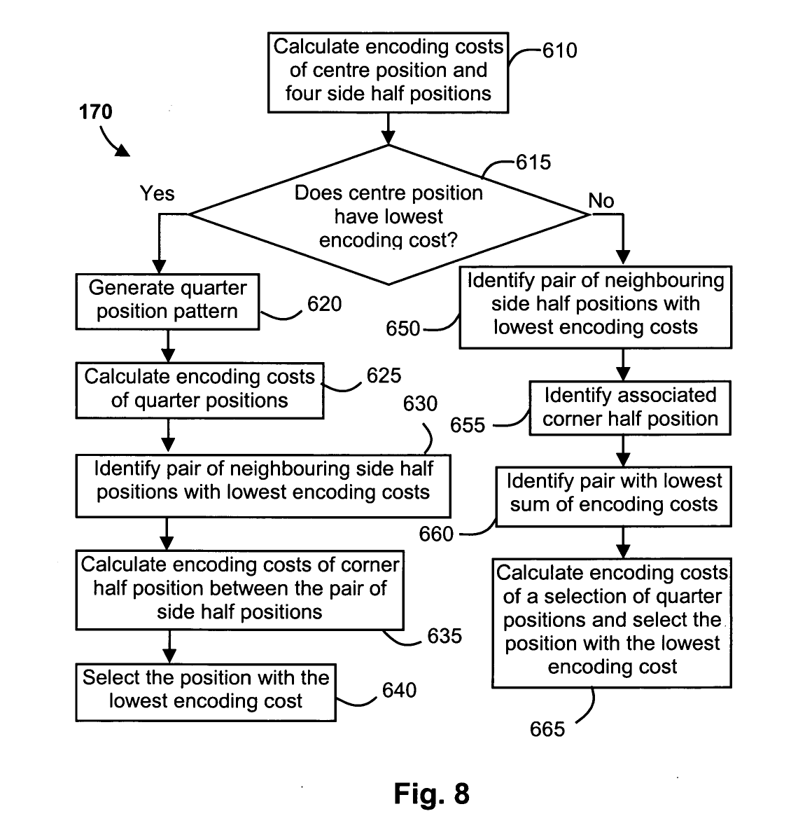

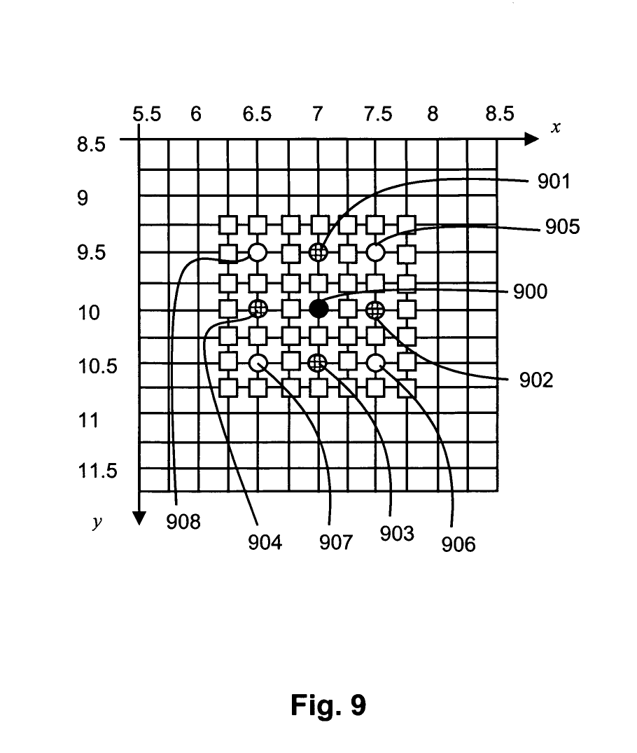

Referring again to FIG. 1, having estimated an integer level motion vector in step 10, the method 100 continues to step 20 where that integer level motion vector is refined by estimating an inter-pixel level motion vector. FIG. 8 is a schematic flow diagram showing the sub-steps of step 20 (FIG. 1). FIG. 9 shows inter-pixel grid positions spaced in ¼ grid positions. Point 900 is positioned at position (7,10) and corresponds to an integer level motion vector (7,10).

Step 20 starts in sub-step 610 where the encoding cost of the centre position, which is the best motion vector estimated in step 10, is calculated. Also in sub-step 610 the encoding costs of the 4 “side half positions” are calculated, with the side half positions being ½ a pixel grid position from the coordinate of the centre position in the horizontal and vertical directions respectively. Accordingly, and the side half positions of position (7,10) illustrated in FIG. 9 are points 901 to 904 and at positions (7, 9.5), (7.5, 10), (7, 10.5), and (6.5, 10) respectively.

Next, in sub-step 615 it is determined whether the centre position has the lowest encoding cost amongst the encoding costs calculated in sub-step 610. If it is determined in sub-step 615 that the centre position has the lowest encoding cost, then in sub-step 620 a selection of the “quarter positions” surrounding the centre position are identified according to predefined heuristics based on the encoding costs of side half positions. The quarter positions occupy the ¼ grid positions surrounding the centre position which, for the example illustrated in FIG. 9 are at positions (7, 9.75), (7.25, 9.75), (7.25, 10), (7.25, 10.25), (7, 10.25), (6.75, 10.25), (6.75, 10) and (6.75, 9.75) respectively. In sub-step 625 the encoding costs of those selected quarter positions are calculated.

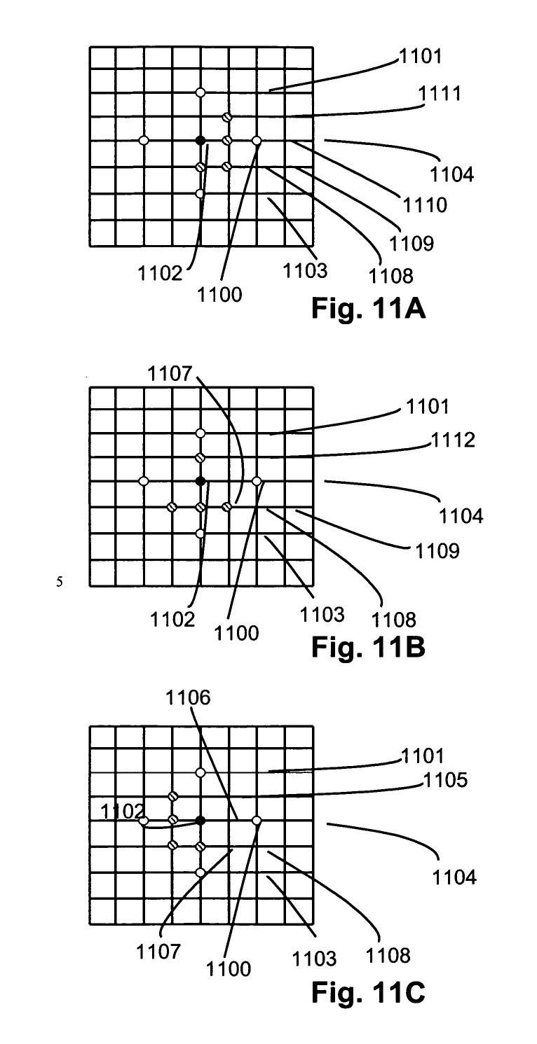

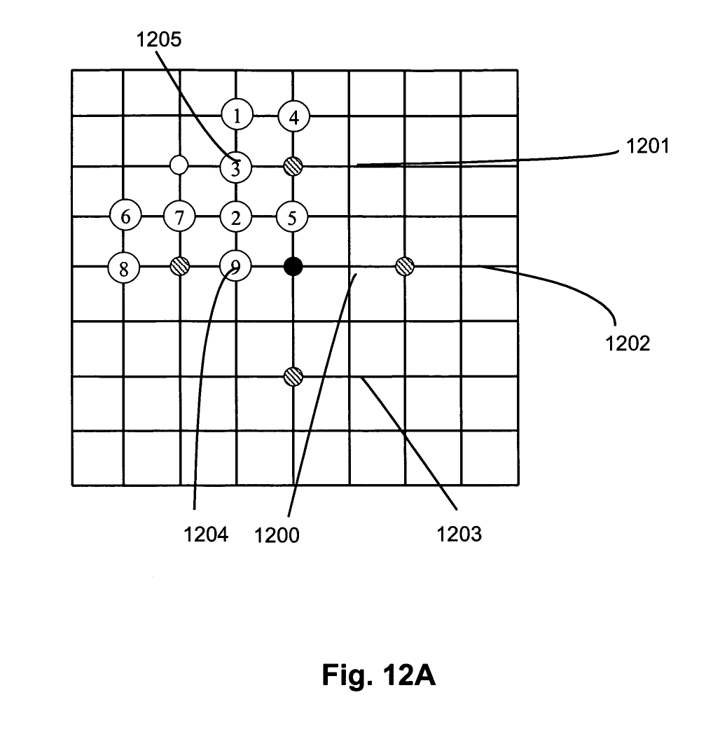

The manner in which the selection of the quarter positions surrounding the centre position are identified in sub-step 620 is firstly based upon the side half position with the lowest encoding costs. Accordingly, the side half position with the lowest encoding cost is identified. Refer to FIG. 11A where a centre position 1100 and its four side half positions 1101 to 1104 are illustrated. Let side half position 1103 be the side half position with the lowest encoding cost. Then, the encoding costs of the side half positions adjacent the side half position with the lowest encoding cost are compared to determine which of those side half positions has the lowest encoding cost. Hence, in the example of FIG. 11A where side half position 1103 has the lowest encoding cost, side half positions 1102 and 1104 are compared. In the case where side half position 1104 has a lower encoding cost than that of side half position 1102 the quarter positions 1108 to 1111, as shown in FIG. 11A, are selected in sub-step 620. Similarly, if the side half position 1102 has a lower encoding cost than that of side half position 1104 the quarter positions 1105 to 1108, as shown in FIG. 11C, are selected. In the event that the encoding costs of side half positions 1102 and 1104 are the same, then the quarter positions 1107 to 1109 and 1112, shown in FIG. 11B, are selected.

Referring again to FIG. 8, next, in sub-step 630, the pair of neighbouring side half positions with the lowest encoding cost amongst all pairs of neighbouring side half positions is identified. In sub-step 635 which follows sub-step 630 the encoding cost of the “corner half position” associated with the pair identified in sub-step 630 is calculated. The corner half positions are ½ a pixel grid position from the coordinate of the centre position in the diagonal directions. Accordingly, and the corner half positions of position (7,10) illustrated in FIG. 9 are points 905 to 908 and at positions (7.5, 9.5), (7.5, 10.5), (6.5, 10.5), and (6.5, 9.5) respectively. Referring to FIG. 9, in the case where the pair of neighbouring side half positions with the lowest encoding cost are those at points 903 and 904, then the identified corner half position is 907.

Finally, in sub-step 640 the position amongst the centre position, the corner half position identified in sub-step 635, and the quarter positions selected in sub-step 620 having the lowest encoding cost is identified. That position is output as the estimated motion vector between the pixel block in the current frame and a pixel block in the reference frame. Following sub-step 640 step 20, and accordingly method 100, ends.

If it is determined in sub-step 615 that the centre position does not have the lowest encoding cost, then in sub-step 650 the pair of neighbouring side half positions with the lowest encoding cost amongst all pairs of neighbouring side half positions is identified. Next, in sub-step 655 the corner half position associated with the pair of neighbouring side half positions with the lowest encoding cost is identified.

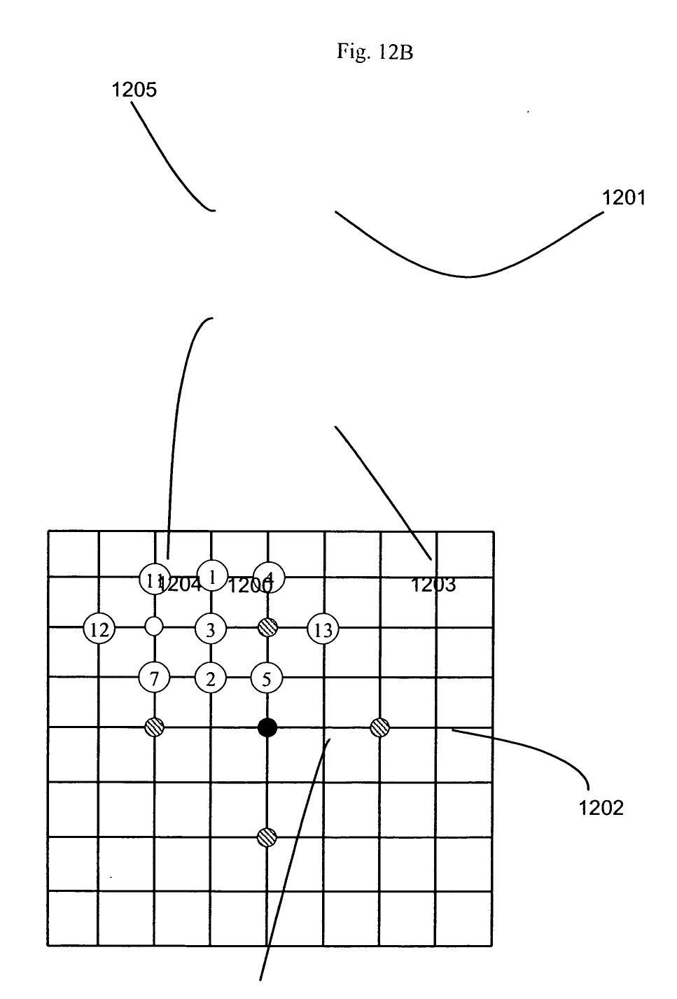

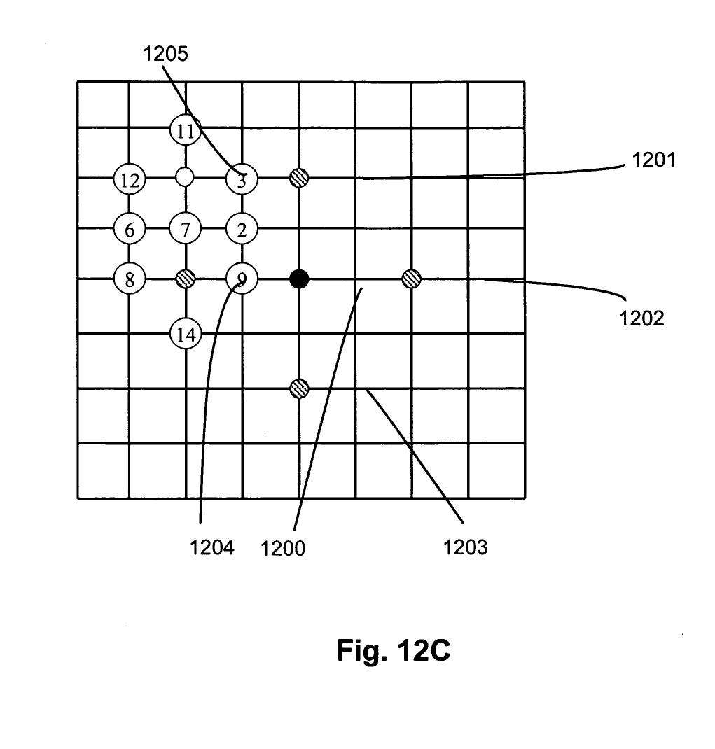

In sub-step 660 the pair of positions from the set including the centre position, the two neighbouring side half positions with the lowest encoding cost, and the associated corner half position is selected which has the lowest sum of encoding costs. Referring to FIG. 12A where position 1200 is the centre position and positions 1201 to 1204 are the side half positions, in the case where the pair of neighbouring side half positions with the lowest encoding cost are at points 1201 and 1204, the associated corner half position is 1205, and the set includes points {1200, 1201, 1204, 1205}. It is known from sub-step 615 that the encoding cost at point 1201 or 1204 is lower than the encoding cost at the centre position 1200. Accordingly, the pair {1200, 1205} can not have the lowest sum of encoding costs. The possible pairs in the example case are {1200, 1201}, {1200, 1204}, {1201, 1205}, {1204, 1205} and {1201, 1204}.

Quarter positions are selected in sub-step 665 based on the pair having the lowest sum of encoding costs identified in sub-step 660. Therefore, the possible quarter positions that have to be checked are minimised to those in the vicinity of the pair having the lowest sum of encoding costs only.

In the case where the pair having the lowest sum of encoding costs is {1200, 1201} the encoding costs at positions 1 and 2 are firstly calculated. If the encoding cost at position 1 is lower than that at position 2, then the encoding costs at positions 3 and 4 are also calculated. If the encoding cost at position 2 is lower than that at position 1, then the encoding costs at positions 3 and 5 are also calculated. The position with the lowest encoding cost is output as the estimated motion vector between the pixel block in the current frame and a pixel block in the reference frame.

In the case where the pair having the lowest sum of encoding costs is {1200, 1204} the encoding costs at positions 2 and 6 are firstly calculated. If the encoding cost at position 6 is lower than that at position 2, then the encoding costs at positions 7 and 8 are also calculated. If the encoding cost at position 2 is lower than that at position 6, then the encoding costs at positions 7 and 9 are also calculated. The position with the lowest encoding cost is output as the estimated motion vector between the pixel block in the current frame and a pixel block in the reference frame.

Referring to FIG. 12B, if the pair having the lowest sum of encoding costs is {1201, 1205} then the position amongst the set {3, 1201, 1205} with the lowest encoding cost is identified. Then, if the encoding cost at position 3 is the minimum the encoding costs at positions 1 and 2 are also calculated. If the encoding cost at position 1205 is the minimum the encoding costs at positions 7, 11 and 12 are also calculated. If the encoding cost at position 1201 is the minimum the encoding costs at positions 4, 5 and 13 are also calculated. The position with the lowest encoding cost is output as the estimated motion vector between the pixel block in the current frame and a pixel block in the reference frame.

Referring to FIG. 12C, if the pair having the lowest sum of encoding costs is {1204, 1205} then the position amongst the set {7, 1204, 1205} with the lowest encoding cost is identified. Then, if the encoding cost at position 7 is the minimum the encoding costs at positions 2 and 6 are also calculated. If the encoding cost at position 1205 is the minimum the encoding costs at positions 3, 11 and 12 are also calculated. If the encoding cost at position 1204 is the minimum the encoding costs at positions 8, 9 and 14 are also calculated. The position with the lowest encoding cost is output as the estimated motion vector between the pixel block in the current frame and a pixel block in the reference frame.

Referring to FIG. 12A, in the case where the pair having the lowest sum of encoding costs is {1201, 1204} then it is determined which of points 1200 and 1205 has the lowest encoding cost. If position 1200 has an encoding cost which is lower than that of position 1205 then the encoding costs at positions 2, 5 and 9 are also calculated. Alternatively, if position 1205 has an encoding cost which is lower than that of position 1200 then the encoding costs at positions 2, 3 and 7 are also calculated. The position with the lowest encoding cost is output as the estimated motion vector between the pixel block in the current frame and a pixel block in the reference frame.

Following sub-step 665 step 20, and accordingly method 100, ends.

From the above it can be seen that the method 100 operates by first identifying in step 10 a best integer motion vector and then refines that integer motion vector in step 20 to thereby estimate a motion vector to inter-pixel level. As the search space is reduced by step 10, it is possible to effectively locate a best motion vector to an inter-pixel level in step 20 by only searching positions surrounding the best motion vector estimated in step 10.

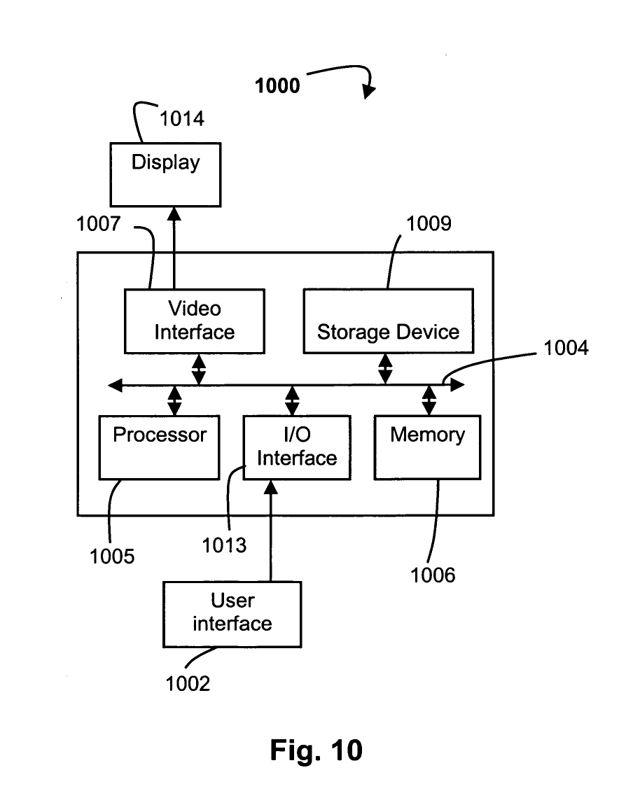

The method 100 of estimating a motion vector between a pixel block in the current frame and a pixel block in the reference frame may be implemented using a computing device 1000, such as that shown in FIG. 10 wherein the method 100 is implemented as software. In particular, the steps and sub-steps of method 100 are effected by instructions in the software that are carried out within the computing device 1000. The software may be stored in a computer readable medium, is loaded into the computing device 1000 from the computer readable medium, and then executed by the device 1000. A computer readable medium having such software or computer program recorded on it is a computer program product. The use of the computer program product in the device 1000 preferably effects an advantageous apparatus for estimating a motion vector between a pixel block in the current frame and a pixel block in the reference frame.

As seen in FIG. 10, the device 1000 is formed from a user interface 1002, a display 1014, a processor 1005, a memory unit 1006 a storage device 1009 and a number of input/output (I/O) interfaces. The I/O interfaces include a video interface 1007 that couples to the display 1014, and an I/O interface 1013 for the user interface 1002.

The components 1005, to 1013 of the device 1000 typically communicate via an interconnected bus 1004 and in a manner which results in a conventional mode of operation known to those in the relevant art. Typically, the software is resident on the storage device 1009 and read and controlled in execution by the processor 1005.

The foregoing describes only some embodiments of the present invention, and modifications and/or changes can be made thereto without departing from the scope and spirit of the invention, the embodiments being illustrative and not restrictive.

We claim:

1. A method of estimating a motion vector between a first pixel block in a current frame and a second pixel block in a reference frame, said method comprising the steps of:
predicting a first motion vector based upon at least the motion vector of a third pixel block; and
selecting the best motion vector from a group of motion vectors in a first pattern around said first motion vector, said first pattern being based upon the direction of said first motion vector and distortion resulting from applying said first motion vector.

2. The method according to claim 1, wherein said third pixel block is in said current frame.

3. The method according to claim 1, wherein said third pixel block is a pixel block in a frame preceding said current frame.

4. The method according to claim 3, wherein said third pixel block is spatially collocated to said first pixel block.

5. The method according to claim 1, comprising the further step of scaling said first pattern based upon a distortion level resulting from applying said first motion vector.

6. The method according to claim 1, comprising the further steps of:
scaling a second pattern based upon a distortion level resulting from applying said best motion vector; and
selecting a replacement best motion vector from a group of motion vectors in said second pattern around said best motion vector.

7. The method according to claim 6, wherein said scaling said second pattern and said selecting said replacement best motion vector steps are repeated iteratively.

8. The method according to claim 1, comprising the further steps of:
refining said best motion vector to sub-pixel resolution by selecting a replacement best motion vector from a group of motion vectors in a third pattern in the inter-pixel neighbourhood of said best motion vector.

9. The method according to claim 8, wherein said third pattern is based upon the distribution of encoding costs resulting from said best motion vector and at least the encoding cost of a pair of side half positions and an associated corner half position located in said inter-pixel neighbourhood of said best motion vector.

10. Apparatus for estimating a motion vector between a first pixel block in a current frame and a second pixel block in a reference frame, said apparatus comprising:
means for predicting a first motion vector based upon at least the motion vector of a third pixel block; and
means for selecting the best motion vector from a group of motion vectors in a first pattern around said first motion vector, said first pattern being based upon the direction of said first motion vector and distortion resulting from applying said first motion vector.

11. The apparatus according to claim 10, wherein said third pixel block is in said current frame.

12. The apparatus according to claim 10, wherein said third pixel block is a pixel block in a frame preceding said current frame.

13. The apparatus according to claim 12, wherein said third pixel block is spatially collocated to said first pixel block.

14. The apparatus according to claim 10, further comprising:
means for scaling said first pattern based upon a distortion level resulting from applying said first motion vector.

15. The apparatus according to claim 10, further comprising:
means for scaling a second pattern based upon a distortion level resulting from applying said best motion vector; and
means for selecting a replacement best motion vector from a group of motion vectors in said second pattern around said best motion vector.

16. The apparatus according to claim 10, further comprising:
means for refining said best motion vector to sub-pixel resolution by selecting a replacement best motion vector from a group of motion vectors in a third pattern in the inter-pixel neighbourhood of said best motion vector.

17. The apparatus according to claim 16, wherein said third pattern is based upon the distribution of encoding costs resulting from said best motion vector and at least one inter-pixel motion vector located in said inter-pixel neighbourhood of said best motion vector.
